(19) United States
(12) Patent Application Publication
(10) Pub. No.: US 2009/0138931 A1
(43) Pub. Date: May 28, 2009

(54) Method and Apparatus for Processing Video Stream in a Digital Video Broadcasting System

(75) Inventors: Guo Hui Lin, Beijing (CN); Yonghua Lin, Beijing (CN); Yudong Yang, Beijing (CN); Yu Yuan, Beijing (CN)

Correspondence Address: Anne Vachon Dougherty, 3173 Cedar Road, Yorktown Hts, NY, 10598, US

(73) Assignee: International Business Machines Corporation, Armonk, NY (US)

(21) Appl. No.: 12/163,879

(22) Filed: Jun. 27, 2008

(30) Foreign Application Priority Data
Jun. 29, 2007 (CN) 200710126858.2

(51) Int. Cl. H04N 7/173

(52) U.S. Cl. 725/115; 725/131; 725/120

(57) ABSTRACT

A novel method and system for enhancing user experience when switching channel in digital video broadcasting system is proposed. The invention proposes a server-based cache mechanism which caches all channels simultaneously in a cache server near from the video playing terminal. The channel switch latency could be heavily reduced since the initial part of the current GOP of any channel could be retrieved from the cache server, therefore the user experience is improved greatly.

### TECHNICAL FIELD

The present invention relates to a method and system for processing video stream in digital video broadcasting system, in particular, a method and system for enhancing user experience when switching channels.

### BACKGROUND OF THE INVENTION

Digital video broadcasting systems have to rely heavily on an advanced digital video encoding algorithm in order to provide vivid contents over the limited bandwidth of transmission channels. Most of today's video coding algorithms take advantage of predictive coding to eliminate the data redundancy between adjacent video frames. Normally the predictive coding starts with one video frame coded without reference to any other video frame (referred to as an Intra coded frame or I-frame). The succeeding video frames are predicted based on the I-frame and other video frames coded before them (referred to as reference frames) The group of video pictures mentioned above is usually called one GOP (Group of Pictures), as shown in FIG. 1. It is apparent that one GOP can only be decoded starting from the first I-frame. Theoretically a 90 minute movie can be compressed in one GOP structure, but the inconvenience is apparent: one cannot start watching from somewhere in the middle. While it would be most convenient to have very short GOP structure, too many I-frames will harm the efficiency of video coding as the I-frames can only be coded very inefficiently compared with the predictive coded frames. The usual trade-off is GOP structures with lengths from several to tens of seconds. In video coding standards such as MPEG-2, limited length for a GOP is also suggested because the accumulation of predictive coding errors may cause visual artifacts.

In a digital video broadcasting system, there are usually multiple video program streams being broadcasted simultaneously. The end users watch the video content by selecting a content stream to play. A channel switch is done by switching to another video stream and then restarting the decoding process. As shown in FIG. 2, where the user switches the channel from stream X to Y, if the switch point happens just a short period after the start of a new GOPm+1 in stream Y, the decoding of stream Y shall not be able to start until the new GOPm+2 arrives. It is simply because one cannot get the complete data of GOPm+1 when the switching happens, especially the leading I-frame, to start decoding correctly. Depending on the length of GOP structure, the user may have to wait for several or tens of seconds before the new channel shows. During the wait, the screen either displays a frozen frame from the last channel or is completely blank. Compared to the instant channel switch experience that the users are familiar with in analog TV days, the long latency during channel switch of digital TV poses a very bad user experience. The situation becomes even worse with the introduction of new video coding standards such as MPEG-4 and H.264, where the preferred GOP length is in the range of tens of seconds in order to reach extremely high coding efficiency.

There are some known solutions to the above problem:

One direct solution is to use short GOP structures in the high resolution content streams. The major drawback of this solution is low coding efficiency that results in either low video quality with limited bandwidth or high bandwidth utilization with designated video quality.

Another possible solution is to use layered video coding technique with low resolution coding layers using short GOP structures while high resolution coding layers (also known as enhanced layer) use long GOP structures. The decoding of high resolution coding layers has to be carried out after the decoding of low resolution coding layers, because high resolution coding layers need prediction not only from the same layer but from low resolution coding layers. No layered video coding technique is used in the current digital video broadcasting schemas due to complexity and high cost.

It is also proposed that the program stream be decoded using the incomplete GOP data so that there will be some dynamic images shown on the screen. However, the quality of the resulted image is very poor due to the incomplete data. As shown in FIG. 8b, heavy block artifacts will be shown. In most user experiences, these kinds of artifacts are barely acceptable.

Another known solution to this problem is to let the video playing terminal (e.g. a set-top-box) cache the previous and the next channel (in terms of the channel number) during the playing of the current channel, so if the user switches to the previous channel or the next channel, the playing could be started shortly since the current GOP can be accessed (the broadcasted part of the GOP is stored locally). However, this solution has the following drawbacks: 1) If the user switches channel by inputting a channel number directly, or switches channel continuously but rapidly, this solution does not work since the terminal has no chance to cache the to-be-watched channel; and 2) due to the limit of the tuner number and/or the storage space in the terminal, it is not practical to cache all channels simultaneously.

### SUMMARY OF THE INVENTION

The present invention proposes a novel method and system for enhancing user experience in a digital video broadcasting system, in particular, a method and system for enhancing user experience when switching channel.

According to one aspect of the present invention, a method for processing content streams in a digital video broadcasting system is provided. The digital video broadcasting system includes a broadcasting frond-end, a cache server and at least one video playing terminal. The content streams constitute image group structures for the video playing terminal to play. The method comprises the steps of: in response to the selection of the channel by a user, requesting a cached content stream corresponding to the selected channel from the cache server which is used to cache content streams corresponding to at least one channel come from the broadcasting frond-end; receiving the cached content stream corresponding to the selected channel from the cache server, wherein the cached content stream comprises at least the initial part of the current image group structure; and, decoding and playing the content stream corresponding to the selected channel.

According to one embodiment of the present invention, the decoded and played content stream corresponding to the selected channel is the cached content stream from the cache server. According to another embodiment of the present invention, the method further comprises the step of, in response to the selection to the channel by the user, obtaining the broadcasting frond-end content stream corresponding to the selected channel from the broadcasting frond-end, wherein, the decoded and played content stream corresponding to the selected channel is comprised of the cached content stream from the cache server and the obtained broadcasting frond-end content stream.

Preferably, the cached content stream corresponding to the selected channel is transmitted from the cache server to the video playing terminal in the way of unicast.

According to another aspect of the present invention, a method for processing content streams in a digital video broadcasting system is provided. The digital video broadcasting system includes a broadcasting frond-end, a cache server and at least one video playing terminal. And the content streams constitute image group structures for the video playing terminal to play. The method comprises the steps of: the cache server receiving the content stream corresponding to at least one channel from the broadcasting frond-end; caching the content stream in the cache server; and, in response to the selection of the channel by a user from a video playing terminal, the cache server sending the cached content stream corresponding the selected channel to the video playing terminal. The content stream cached by the cache server for each channel is comprised of at least the initial part of current image group structure.

According to another aspect of the present invention, a video playing terminal for processing content streams in a digital video broadcasting system is provided. The digital video broadcasting system includes a broadcasting frond-end, a cache server and the video playing terminal. The content streams constitute image group structures for the video playing terminal to play. The video playing terminal comprises: means for, in response to the selection of the channel by a user, requesting a cached content stream corresponding the selected channel from the cache server which is used to cache content streams corresponding to at least one channel come from the broadcasting frond-end; means for receiving the cached content stream corresponding to the selected channel from the cache server, wherein the cached content stream comprises at least the initial part of the current image group structure; and means for decoding and playing the content stream corresponding to the selected channel.

According to another aspect of the present invention, a device for processing content streams in a digital video broadcasting system is provided. The digital video broadcasting system includes a broadcasting frond-end and at least one video playing terminal. And the content streams constitute image group structures for the video playing terminal to play. The device comprises: means for receiving the content stream corresponding to at least one channel from the broadcasting frond-end; means for caching the content stream, wherein the content stream cached for each channel is comprised of at least the initial part of current image group structure; and, means for, in response to the selection of the channel by a user from a video playing terminal, sending the cached content stream corresponding to the selected channel to the video playing terminal.

According to another aspect of the present invention, a computer program product comprising computer readable codes embodied in a computer readable storage medium for executing the method according to the present invention is provided.

The present invention proposes a server-based cache mechanism which caches all channels simultaneously in a cache server “near from” the video playing terminal. The channel switch latency could be heavily reduced since the broadcasted part of the current GOP of any channel (necessary information to decode the current GOP) could be retrieved from the cache server. Compared with the known solution described before, the present invention has the following advantages:

The present invention reduces the channel switch latency between any two channels instead of only adjacent channels. And the improvement would not be affected by the channel switch speed/frequency of the user.

Such a cache server could serve many video playing terminals simultaneously, so the cost of more tuners or storage in the server is not as critical as the cost of each terminal. Actually, the solution architect could balance the server cost and the number of served terminals.

### BRIEF DESCRIPTION OF THE DRAWINGS

The present invention will be understood and appreciated more comprehensively from the following detailed description of the invention, taken in conjunction with the accompanying drawings of which:

FIG. 1 is a diagram showing the video GOP structure in the prior art;

FIG. 2 is a diagram showing that the image is displayed according to the video GOP structure when the channel is switched in the prior art;

FIG. 3 is a flowchart showing a method of switching channels in the prior art;

FIGS. 4a and 4b show the relationship among broadcasting frond-end, cache server and video playing terminal according to the first embodiment and the second embodiment of the present invention, respectively;

FIG. 5 shows a block diagram of a cache server according to the present invention;

FIGS. 6a and 6b show the flowcharts of the methods according to the first embodiment and the second embodiment of the present invention, respectively;

FIGS. 7a and 7b are diagrams showing that the image is displayed according to the video GOP structure when the channel is switched according to the present invention; and

FIGS. 8a and 8b are diagrams showing the displayed image.

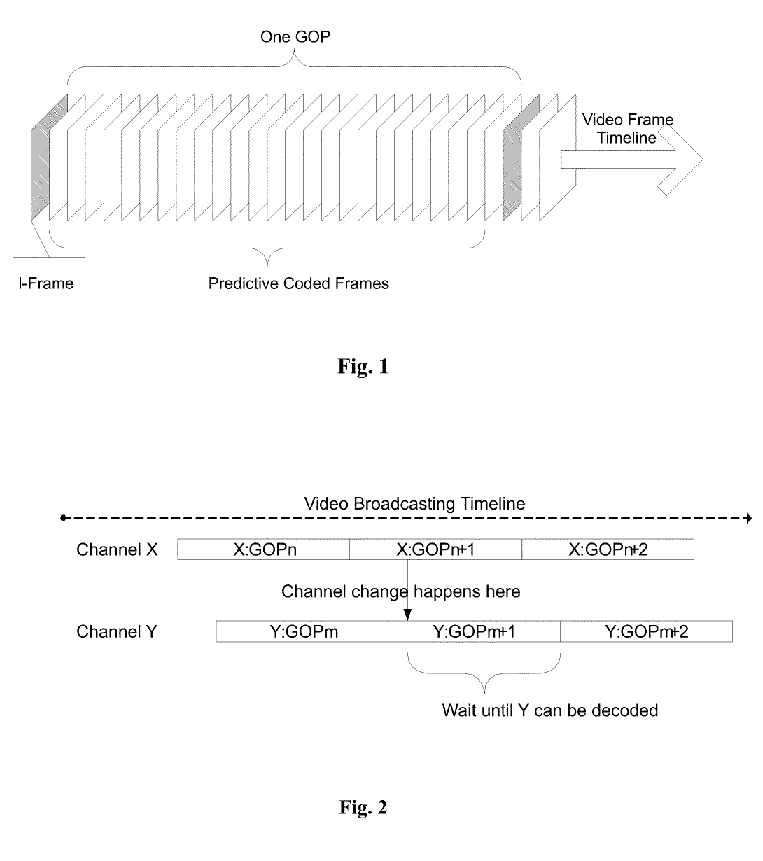

### DETAILED DESCRIPTION OF THE INVENTION

The method for processing content stream in digital video broadcasting system according to the invention will be described in detail with reference to the accompanying drawings here below. It should be noted that the description here below is only for the purpose of illustration but not to limit the invention. A lot of technical details will be described in order that one having skill in the art will be able to implement the invention according to the description, but this does not mean that the invention must be implemented with these technical details; on the contrary, the invention can be implemented without some of the features or with some other additional features.

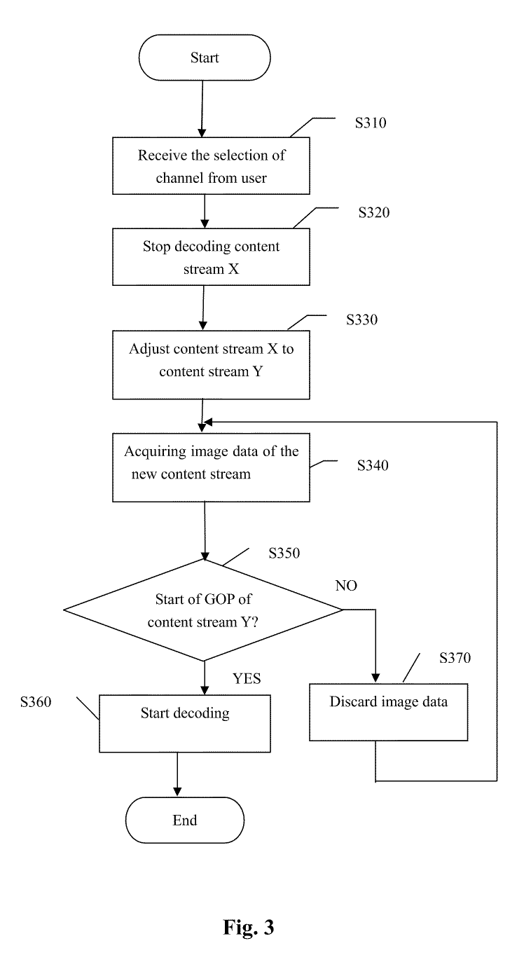

For the purpose of a better illustration of the method of the invention, the flow of a common channel switch in digital video broadcasting system in prior arts will be described with reference to FIG. 3.

After receiving a selection of a new channel from user at step S310, the process proceeds into step S320 in which the decoding of current content stream X in the decoder is stopped and the buffer in the decoder is cleared. At this time, normally a blank screen or a frozen video frame of current content stream X is shown.

The flow then proceeds to step S330 in which the content stream to be played is tuned to a new content stream Y by changing some system parameters. Since this step is a well-known step in the prior art, for simplicity, it is not described in detail here.

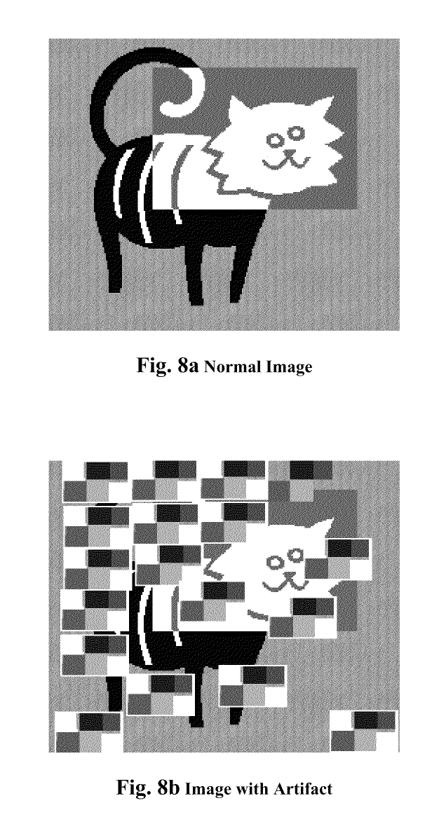

Then, the flow proceeds to step S340 in which the image data of content stream Y is acquired. At step S350, it is determined whether a new GOP has arrived or not. If yes, at step S360, the decoding of the image data of content stream Y is started in the decoder and the decoded new content stream Y is displayed on the screen, as shown in FIG. 8a. If the result of the determination at step S350 shows that no new GOP has arrived, the image data will be discarded at step S370 and the flow will return to step S340 to continue to acquire image data.

It can be seen from the process described above that, in order to avoid displaying artifacts as shown in FIG. 8b, the decoder must wait until the new GOP of content stream Y has arrived to start real decoding. When the GOP structure is long, the waiting period will probably lead to or cause a blank screen or a still image of the last channel for a rather long period.

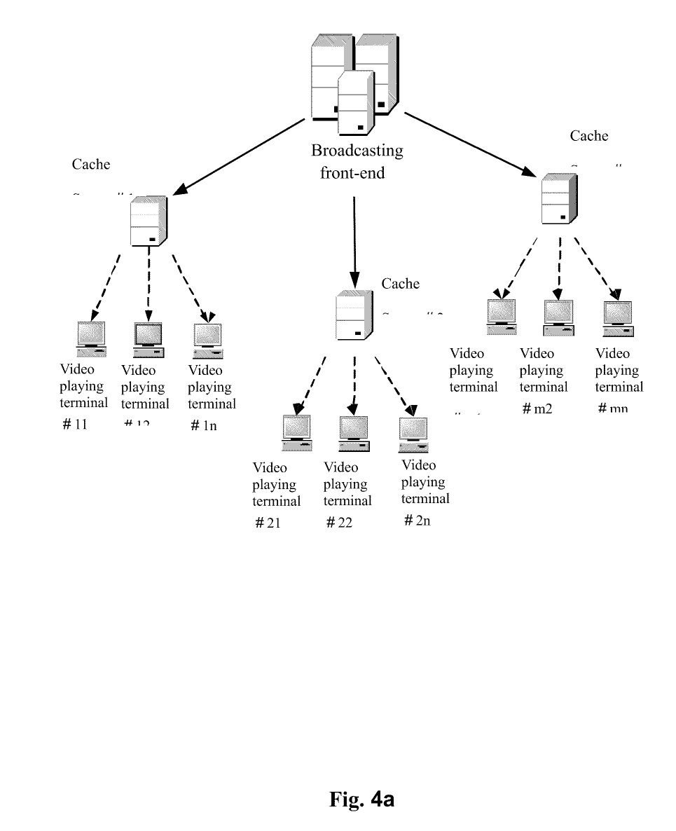

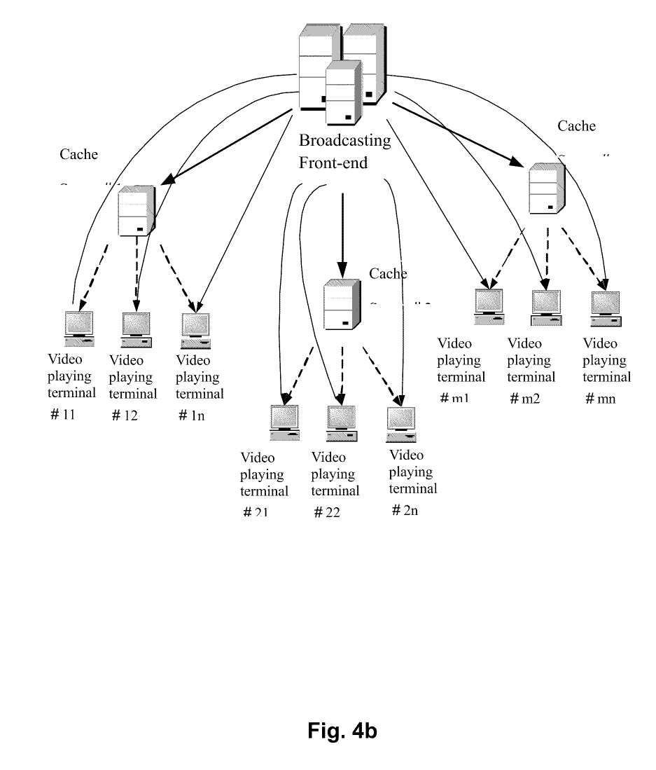

To overcome the above drawbacks in the prior art, a server-based cache mechanism is proposed by the present invention, which caches all channels simultaneously in a cache server “near from” the video playing terminal. Now two embodiments of the cache mechanism for improving the user experience when switching channels according to the present invention are described in conjunction with the diagrams in FIGS. 4a and 4b. FIGS. 4a and 4b show the relationship among the broadcasting frond-end, the cache server and the video playing terminal. It can be seen from the figures that there is a cache server near the video playing terminal. The cache server receives the content stream of the channels broadcasted from the broadcasting frond-end and caches them. In the embodiment as shown in FIG. 4a, the video playing terminals receive the cached content stream of the channels from the cache server instead of from the broadcasting frond-end. And in the embodiment as shown in FIG. 4b, the video playing terminals receive the content stream of the channels from the broadcasting frond-end. At the same time, the video playing terminals request the content stream corresponding to a specific channel as needed from the cache server, in which the data necessary to the current GOP are included.

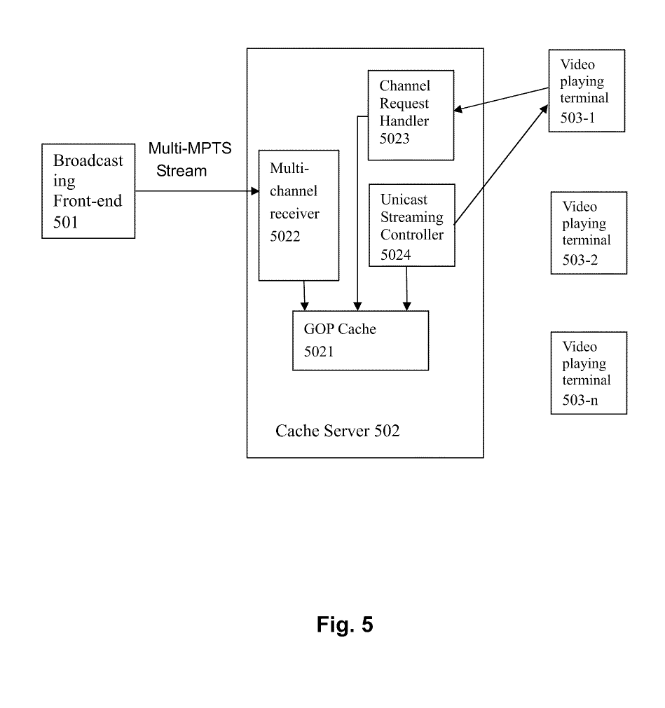

FIG. 5 shows a block diagram of a cache server according to the present invention. The cache server 502 includes a GOP cache 5021, a multi-channel receiver 5022, a channel requests handler 5023, and a unicast streaming controller 5024. The multi-channel receiver 5022 receives the content stream for multiple channels from the broadcasting frond-end 501, and stores them into the GOP cache 5021. The GOP cache 5021 stores the content stream including at least the initial part of the current GOP for each channel. When the request from the user for a specific channel is received from the video playing terminal 503-1, the channel requests handler 5023 proceeds the request, retrieves the content stream including the initial part of the current GOP corresponding to the specific channel, and sends it to the unicast streaming controller 5024. The unicast streaming controller 5024 sends the above content stream to the video playing terminal 503-1 to play in a unicast way. It is to be noted that sending the content stream to the video playing terminal from the cache server in a unicast way is only a preferred embodiment of the present invention and the present invention is not limited to such a unicast way. In fact, any appropriate way known to those skilled in the art can be used to send data to the video playing terminal from the cache server to obtain the objective of the present invention.

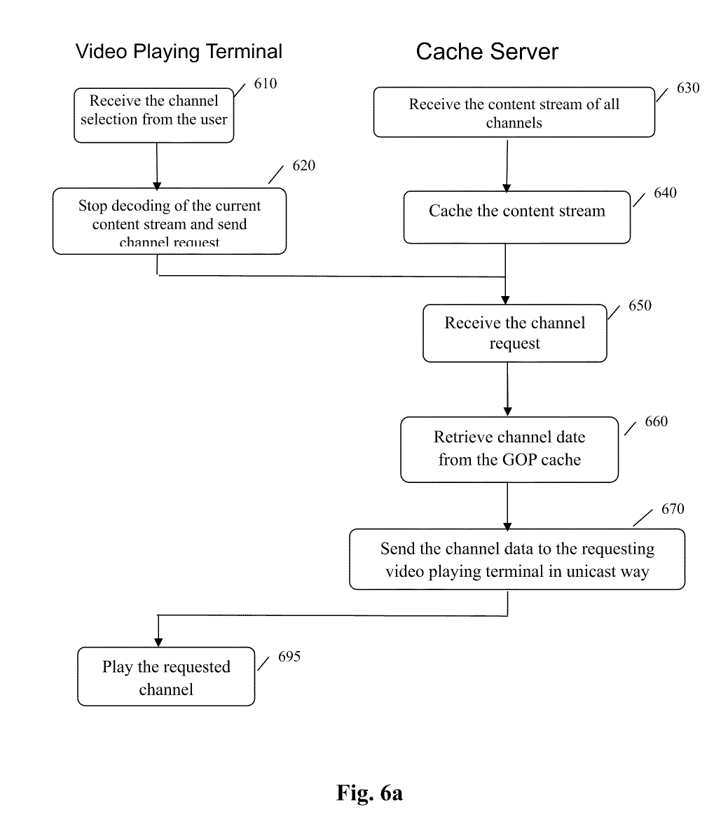

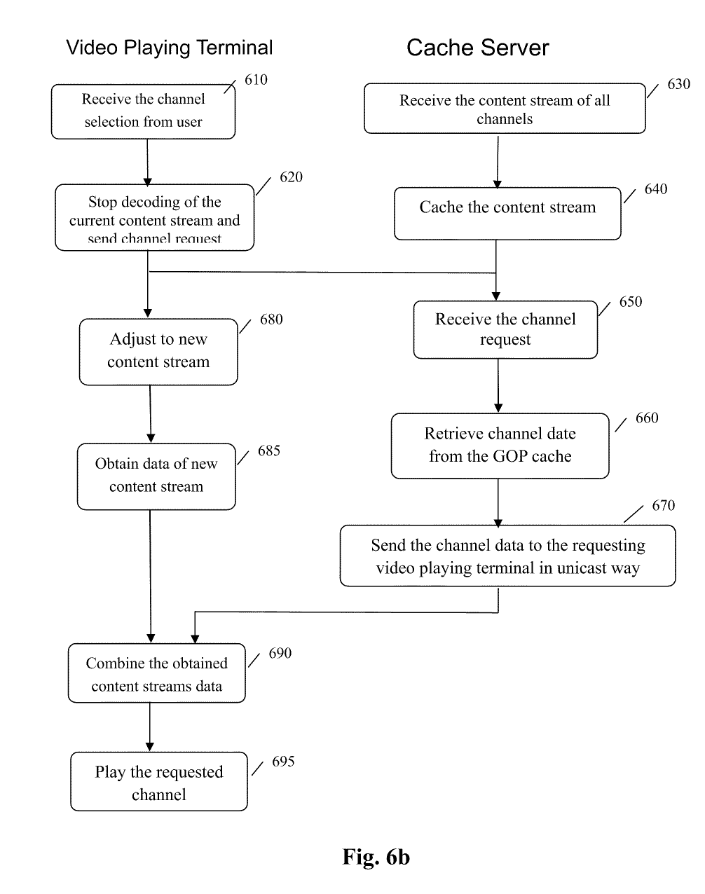

FIGS. 6a and 6b show the flowcharts of the methods according to the first embodiment and the second embodiment of the present invention, respectively. In FIGS. 6a and 6b, the same or similar steps are identified by the same reference number. Wherein, step S610, S620, S680, S685 and S690, S695 are performed at the side of video playing terminal. And steps S630-S670 are performed at the side of cache server.

Now the first embodiment of the present invention is described with reference to FIG. 6a. In the first embodiment, a digital video broadcasting system as shown in FIG. 4a is used, in which a cache server is connected with a broadcasting frond-end, and the video playing terminals are only connected with the cache server. All content streams for the channels which are decoded and played in the video playing terminals come from the cache server.

In step S610, if video playing terminal detects that a channel switch request input from the user is received, it stops the decoding to the current content stream in step S620, clears the buffer of the decoder, and sends the channel switch request to the cache server. At this time, normally a black image or a still video frame of the current content stream X is displayed on the screen.

At the same time, at the cache server side, in step S630, the cache server receives all of the content streams of all channels and, in step S640, caches all of the received content streams of all channels to the GOP cache on the cache server. For each channel, at least the initial part of the current GOP is stored in the GOP cache. In step S650, the cache server retrieves the content stream data corresponding to the requested channel from the GOP cache, the content stream data including at least the initial part of data of the current GOP. In step S660, the cache server sends the retrieved content stream data corresponding to the requested channel to the requesting video playing terminal in a unicast way.

In step S695, with reference to the content stream data obtained from the cache server, which corresponds to the new channel and includes the initial part of the current GOP, the video playing terminal decodes and displays the content stream.

In this embodiment, since the video obtains the content stream data of the channels from the cache server, whenever the user switches the channel, a part of the current GOP of the new channel (necessary information for the current GOP decoding) can be obtained from the cache server, therefore the channel switch delay will be reduced significantly. Furthermore, in this embodiment there is no need to make any change to the current video playing terminal.

FIG. 6b shows another preferred embodiment according to the present invention. In this embodiment, a digital video broadcasting system as shown in FIG. 4b is used, in which the video playing terminals are not only connected to the cache server, but also can receive the content stream of the channels from the broadcasting frond-end directly. Thus, when necessary, the video playing terminal can request the content stream of a specific channel, which includes the data necessary for the current GOP, from the cache server. Therefore, in the flowchart of the present method, besides the steps as shown in FIG. 6a, the video playing terminal also obtains the content stream of the corresponding channel from the broadcasting frond-end in steps S680 and S685. The same steps as in FIG. 6a are not described here. Specifically, in FIG. 6b, after step S620, the flow proceeds to step S680, where the content stream to be played is adjusted into new content stream Y by changing some system parameters. Since this step is known in the prior art, no detailed description on this step is provided here for conciseness. When the process proceeds to step S685, the image data for the new content stream Y is obtained.

At the same time, similar with FIG. 6a, at the cache server side, the content stream data corresponding to the requested channel is retrieved, and the retrieved content stream data corresponding to the requested channel is sent to the requesting video playing terminal in a unicast way, in which the retrieved content stream data includes at least the data in the initial part of the current GOP.

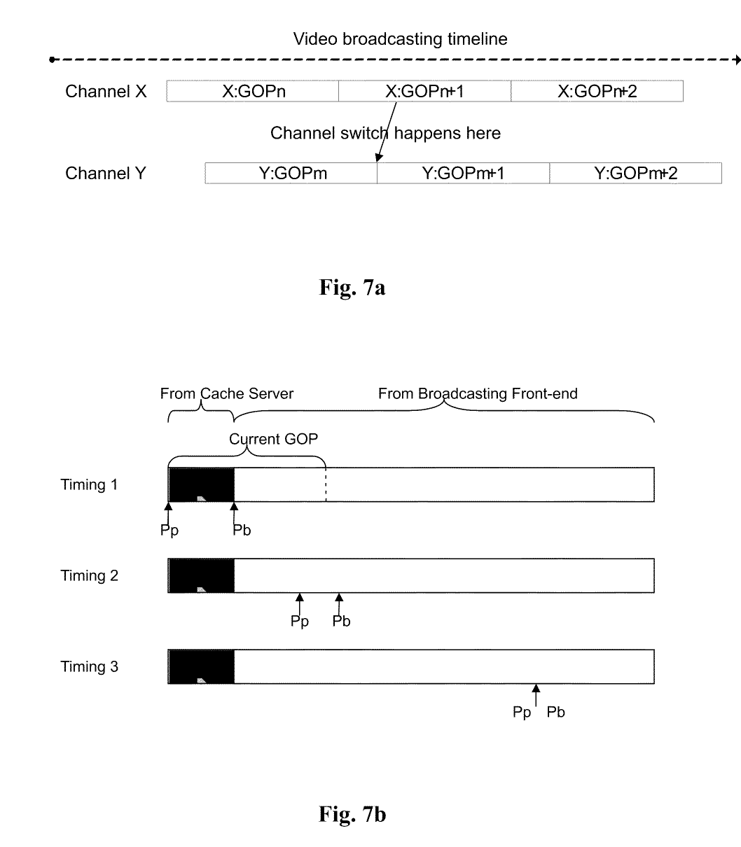

Then, in step S690, the video playing terminal combines the content stream data corresponding to the new channel which is obtained from the broadcasting frond-end and the content stream data including the initial part of the current GOP which is obtained from the cache server. Through the above process, the video playing terminal obtains a content stream Y* corresponding to the new channel Y, which includes the data with the initial part of the current GOP (which is necessary for decoding the current GOP) obtained from the cache server, following the broadcasted portion obtained from the broadcasting frond-end. As shown in FIG. 7(b), there are two important positions in the content stream: the position PP, the position being played on the video playing terminal, and position Pb, the position being broadcasted on the broadcasting frond-end. Before the decoding be restarted, that is, timing 1, Pp<Pbₒ

In Step S695, the video playing terminal decodes and plays the obtained content stream.

As shown in FIG. 7a, the digital video broadcasting system is playing the content stream of channel X. When the (n+1)th GOP of content stream X is being played, a request of switching channel from X to Y is received from the user. At this time, the initial part of the (m+1)th GOP of the channel data of channel Y received from the broadcasting frond-end has past, thus it's not possible to decode the content of the (m+1)th GOP based only on the content stream data received from the broadcasting frond-end. And the video playing terminal can only decodes the content stream Y correctly based on the content stream data including the initial part of the (m+1)th GOP received from the cache server. Thus, almost immediately after the user sent out the channel switch request, an image relating to the new channel can be displayed on the screen.

The process of decoding and playing the image data can be implemented by two different embodiments. On one hand, if the video playing terminal is able to decode at a very high speed (e.g. 16× and above), it may decode as fast as possible and keep the screen blank in the meantime, until Pp reaches Pb at timing 3. The blank duration would be very short since the segment between Pp and Pb is decoded and passed very fast. Thus the waiting time when the user switches channel will be shortened significantly.

On the other hand, if the decoding performance of the video playing terminal is limited, it may decode and play at a speed slightly faster than the normal speed (e.g. 5% faster), until Pp reaches Pb at timing 3. It has been proven that this “gradually pursuing” way is inconspicuous to the users.

Furthermore, before Pp reaches Pb, the content stream to be decoded on the video playing terminal can be comprised of the content stream coming from the cache server when the channel switch happens and the content stream coming from the broadcasting front-end after the channel switch happens. Or the content stream to be decoded on the video playing terminal can be comprised of the content stream coming from the cache server only, until Pp reaches Pb.

In either of the above two embodiments, as long as Pp reaches Pb, the content stream coming from the broadcasting front-end is decoded and played at a normal speed.

Through the above process, since a part of the current GOP of any channel (necessary information for the current GOP decoding) can be obtained from the cache server, the channel switch delay will be reduced significantly, therefore the user experience when switching channel will be enhanced significantly.

The method for enhancing user experiences when switching channels according to the invention has been described in connection with FIGS. 6a and 6b in the above. If fact, the abovementioned method can be applied not only to the situation that users switches channel when they are watching TV, but also to the situation that user has just turned the TV on. The situation that a user turns on a TV is actually a process of selecting a channel. According to the invention, after receiving the select instruction for a channel from the user, according to the present invention, a part of the current GOP is retrieved from the cache server for decoding and playing. This in the same sense enhances the user experience remarkably. In this case, step S520 in the flow diagram shown in FIG. 6 for stopping the decoding of the current content stream is not necessary.

Compared with the alternative solutions in the prior art, the invention is a better tradeoff between cost/complexity of implementation and user experience enhancement. The method according to the present invention is based on currently adopted coding techniques requiring only small changes in software to be implemented in the current digital video broadcasting infrastructure.

Above is the detailed description of the method for switching channel according to the invention. As those skilled in the art can see, the invention can be embodied in the form of method, system and/or computer program product. So the invention can be in the form of hardware, software or combination of thereof.

According to the present invention, a video playing terminal for processing content streams in a digital video broadcasting system is provided. The digital video broadcasting system includes a broadcasting frond-end, a cache server and the video playing terminal. And the content streams constitute image group structures for the video playing terminal to play. The video playing terminal comprises: means for, in response to the selection of the channel by a user, requesting a cached content stream corresponding the selected channel from the cache server which is used to cache content streams corresponding to at least one channel come from the broadcasting frond-end; means for receiving the cached content stream corresponding to the selected channel from the cache server, wherein the cached content stream comprises at least the initial part of the current image group structure; and, means for decoding and playing the content stream corresponding to the selected channel.

Preferably, the decoded and played content stream corresponding to the selected channel is the cached content stream come from the cache server. And preferably, the video playing terminal further comprises of means for, in response to the selection to the channel by the user, obtaining the broadcasting frond-end content stream corresponding to the selected channel from the broadcasting frond-end, wherein, the decoded and played content stream corresponding to the selected channel is comprised of the cached content stream coming from the cache server and the obtained broadcasting frond-end content stream.

The video playing terminal decodes the content stream corresponding to the selected channel with a speed which is higher than the normal playing speed until the content stream that can be played in the video playing terminal is synchronized with the content stream broadcasted from the broadcasting frond-end, wherein, the content stream corresponding to the selected channel is comprised of the cached content stream coming from the cache server when the channel is selected and the broadcasting frond-end content stream coming from the broadcasting frond-end after the channel is selected, or is comprised of the cached content stream coming from the cache server only. And after the content stream that can be played in the video playing terminal is synchronized with the content stream broadcasted from the broadcasting frond-end, the video playing terminal decodes and plays the content stream broadcasted from the broadcasting frond-end with the normal playing speed.

Preferably, when the video playing terminal is decoding the content stream corresponding to the selected channel with a speed which is higher than the normal playing speed, the decoded content stream is displayed on the screen. Or preferably, when the video playing terminal decodes the content stream corresponding to the selected channel with a speed which is higher than the normal playing speed, a blank image is displayed on the screen, until the content stream that can be played in the video playing terminal is synchronized with the content stream broadcasted from the broadcasting frond-end.

According to the present invention, a device for processing content streams in a digital video broadcasting system is provided. The digital video broadcasting system includes a broadcasting frond-end and at least one video playing terminal. And the content streams constitute image group structures for the video playing terminal to play. The device comprises: means for receiving the content stream corresponding to at least one channel from the broadcasting frond-end; means for caching the content stream, wherein the content stream cached for each channel is comprised of at least the initial part of current image group structure; and, means for, in response to the selection of the channel by a user from a video playing terminal, sending the cached content stream corresponding to the selected channel to the video playing terminal. Preferably, the means for receiving the content stream sends the content stream to the video playing terminal in the way of unicast.

In addition, the invention can also be implemented by way of: providing a storage medium with executable codes stored thereon which implement the method described above directly or indirectly to the system or device, and the computer or CPU of the system or device reading out the executable codes and executing the codes.

In this case, as long as the system or the device has the ability to execute the program, the way of implementation will not be limited to program, and the program can be in any form, e.g. target program, program executed by parser or script program provided to the OS.

The computer readable medium abovementioned comprises but is not limit to: memory and storage unit, semiconductor devices, discs such as optical disc, magnetic discs or MO discs and any other medium adapted to store information.

In addition, the invention can also be implemented by the client computer downloading the computer program codes from a certain website from the Internet, installing them to the computer and executing them.

Although the embodiments of the invention are described in detail above in connection with the drawings, it should be understood that all the embodiments described are only for the purpose of illustrating the invention, thus will not limit the invention. For those skilled in the art, variations and modifications can be made without departing from the spirit and scope of the invention, which is defined by the appended claims and their equivalents.

1. A method for processing content streams in a digital video broadcasting system, wherein the digital video broadcasting system includes a broadcasting frond-end, a cache server and at least one video playing terminal, and wherein the content streams constitute image group structures for the video playing terminal to play, the method comprising the steps of:
in response to the selection of the channel by a user, requesting a cached content stream corresponding to the selected channel from the cache server which is used to cache content streams corresponding to at least one channel come from the broadcasting frond-end;
receiving the cached content stream corresponding to the selected channel from the cache server, wherein the cached content stream comprises at least the initial part of the current image group structure; and
decoding and playing the content stream corresponding to the selected channel.

2. The method of claim 1, wherein, the decoded and played content stream corresponding to the selected channel is the cached content stream comes from the cache server.

3. The method of claim 1, further comprising the step of, in response to the selection of the channel by the user, obtaining the broadcasting frond-end content stream corresponding to the selected channel from the broadcasting frond-end,
wherein, the decoded and played content stream corresponding to the selected channel is comprised of the cached content stream coming from the cache server and the obtained broadcasting frond-end content stream.

4. The method of claim 1, wherein, the cached content stream corresponding to the selected channel is transmitted from the cache server to the video playing terminal in the way of unicast.

5. The method of claim 3, wherein, the video playing terminal decodes the content stream corresponding to the selected channel with a speed which is higher than the normal playing speed until the content stream that can be played in the video playing terminal is synchronized with the content stream broadcasted from the broadcasting frond-end, wherein, the content stream corresponding to the selected channel is comprised of the cached content stream coming from the cache server when the channel is selected and the broadcasting frond-end content stream coming from the broadcasting frond-end after the channel is selected, or is comprised of the cached content stream coming from the cache server only; and
after the content stream that can be played in the video playing terminal is synchronized with the content stream broadcasted from the broadcasting frond-end, the video playing terminal decodes and plays the content stream broadcasted from the broadcasting frond-end with the normal playing speed.

6. The method of claim 3, wherein, when the video playing terminal is decoding the content stream corresponding to the selected channel with a speed which is higher than the normal playing speed, the decoded content stream is displayed on the screen.

7. The method of claim 3, wherein, when the video playing terminal decodes the content stream corresponding to the selected channel with a speed which is higher than the normal playing speed, a blank image is displayed on the screen, until the content stream that can be played in the video playing terminal is synchronized with the content stream broadcasted from the broadcasting frond-end.

8. A method for processing content streams in a digital video broadcasting system, wherein said digital video broadcasting system includes a broadcasting frond-end, a cache server and at least one video playing terminal, and wherein the content streams constitute image group structures for the video playing terminal to play, the method comprising the steps of:
the cache server receiving the content stream corresponding to at least one channel from the broadcasting frond-end;
caching the content stream in the cache server; and
in response to the selection of the channel by a user from a video playing terminal, the cache server sending the cached content stream corresponding to the selected channel to the video playing terminal.

9. The method of claim 8, wherein the content stream cached by the cache server for each channel is comprised of at least the initial part of current image group structure.

10. The method of claim 8, wherein, the cache server sends the content stream to the video playing terminal in the way of unicast.

11. A video playing terminal for processing content streams in a digital video broadcasting system, wherein the digital video broadcasting system includes a broadcasting frond-end, a cache server and the video playing terminal, and wherein the content streams constitute image group structures for the video playing terminal to play, the video playing terminal comprising:
means for, in response to selection of the channel by a user, requesting a cached content stream corresponding to the selected channel from the cache server which is used to cache content streams corresponding to at least one channel coming from the broadcasting frond-end;
means for receiving the cached content stream corresponding to the selected channel from the cache server, wherein the cached content stream comprises at least the initial part of the current image group structure; and
means for decoding and playing the content stream corresponding to the selected channel.

12. The video playing terminal of claim 11, wherein, the decoded and played content stream corresponding to the selected channel is the cached content stream from the cache server.

13. The video playing terminal of claim 11, further comprising means for, in response to the selection to the channel by the user, obtaining the broadcasting frond-end content stream corresponding to the selected channel from the broadcasting frond-end,
wherein, the decoded and played content stream corresponding to the selected channel is comprised of the cached content stream come from the cache server and the obtained broadcasting frond-end content stream.

14. The video playing terminal of claim 11, wherein, the cached content stream corresponding to the selected channel is transmitted from the cache server to the video playing terminal in the way of unicast.

15. The video playing terminal of claim 13, wherein, the video playing terminal decodes the content stream corresponding to the selected channel with a speed which is higher than the normal playing speed until the content stream that can be played in the video playing terminal is synchronized with the content stream broadcasted from the broadcasting frond-end, wherein, the content stream corresponding to the selected channel is comprised of the cached content stream coming from the cache server when the channel is selected and the broadcasting frond-end content stream coming from the broadcasting frond-end after the channel is selected, or is comprised of the cached content stream coming from the cache server only; and
after the content stream that can be played in the video playing terminal is synchronized with the content stream broadcasted from the broadcasting frond-end, the video playing terminal decodes and plays the content stream broadcasted from the broadcasting frond-end with the normal playing speed.

16. The video playing terminal of claim 13, wherein, when the video playing terminal is decoding the content stream corresponding to the selected channel with a speed which is higher than the normal playing speed, the decoded content stream is displayed on the screen.

17. The video playing terminal of claim 13, wherein, when the video playing terminal decodes the content stream corresponding to the selected channel with a speed which is higher than the normal playing speed, a blank image is displayed on the screen, until the content stream that can be played in the video playing terminal is synchronized with the content stream broadcasted from the broadcasting frond-end.

18. A device for processing content streams in a digital video broadcasting system, wherein said digital video broadcasting system includes a broadcasting frond-end and at least one video playing terminal, and wherein the content streams constitute image group structures for the video playing terminal to play, the device comprising:
means for receiving the content stream corresponding to at least one channel from the broadcasting frond-end;
means for caching the content stream, wherein the content stream cached for each channel is comprised of at least the initial part of a current image group structure; and
means for, in response to the selection of the channel by a user from a video playing terminal, sending the cached content stream corresponding to the selected channel to the video playing terminal.

19. The device of claim 18, wherein, the means for receiving the content stream sends the content stream to the video playing terminal in the way of unicast.

20. A computer program product comprising computer readable codes stored on a computer readable storage medium for executing a method for processing content streams in a digital video broadcasting system, wherein the digital video broadcasting system includes a broadcasting frond-end, a cache server and at least one video playing terminal, and wherein the content streams constitute image group structures for the video playing terminal to play, the method comprising the steps of:
in response to the selection of the channel by a user, requesting a cached content stream corresponding to the selected channel from the cache server which is used to cache content streams corresponding to at least one channel come from the broadcasting frond-end;
receiving the cached content stream corresponding to the selected channel from the cache server, wherein the cached content stream comprises at least the initial part of the current image group structure; and
decoding and playing the content stream corresponding to the selected channel.
